(19) United States
(12) Patent Application Publication
(10) Pub. No.: US 2016/0346801 A1
(43) Pub. Date: Dec. 1, 2016

(54) TWO COMPONENT PROPORTIONER

(71) Applicant: GRACO MINNESOTA INC., Mineapolis, MN (US)

(72) Inventors: Mark J. BRUDEVOLD, Fridley, MN (US); Robert A. PRIGGE, St. Paul Park, MN (US)

(21) Appl. No.: 14/911,327

(22) PCT Filed: Dec. 17, 2015
(86) PCT No.: PCT/US2015/066452

§ 371 Date: Feb. 10, 2016

Related U.S. Application Data
(60) Provisional application No. 62/093,860, filed on Dec. 18, 2014.

(51) Int. Cl. B05B 12/08; B05B 7/04; B05B 12/14; B05B 7/22; B05B 7/26; B05B 7/00; B05B 7/16

(52) U.S. Cl. CPC B05B 12/085; B05B 7/0093; B05B 7/0408; B05B 7/1693; B05B 7/22; B05B 7/26; B05B 12/1436

(57) ABSTRACT

In one embodiment, a plural component dispensing system includes a first pump, a second pump, a first electric motor, a second electric motor, a first pressure sensor, a second pressure sensor, a first controller, a second controller, and a sprayer. The first pump discharges a first component. The second pump discharges a second component. The first electric motor drives the first pump as a function of a first drive signal. The second electric motor drives the second pump as a function of a second drive signal. The first pressure sensor is located downstream of the first pump and senses a first component pressure. The second pressure sensor is downstream of the second pump and senses a second component pressure. The first controller is configured to produce the first drive signal, and the second controller is configured to produce the second drive signal.

### CROSS-REFERENCE TO RELATED APPLICATION(S)

This application claims priority to U.S. Provisional Application No. 62/093,860, filed Dec. 18, 2014 for “Two Component Proportioner” by M. Brudevold and R. Prigge.

### INCORPORATION BY REFERENCE

The aforementioned U.S. Provisional Application No. 62/093,860 is hereby incorporated by reference in its entirety.

### BACKGROUND

Some spray systems are designed to dispense plural component materials (e.g. paint, adhesive, epoxy, and the like), which require multiple components to be dispensed. Typically, a two-component dispensing system uses a component which is chemically inert in its isolated form, and a catalyst material which is also chemically inert in its isolated form. When the catalyst and the component are combined, an immediate chemical reaction begins taking place that results in cross-linking, curing, and solidification of the mixture. Therefore, the two components are routed separately into the proportioner so that they can remain separate as long as possible. As the chemical reaction takes place, but before it has progressed too far, the mixed material can be dispensed or sprayed into its intended form and/or position. A sprayer receives and mixes the components so the mixture can be dispensed from the sprayer.

A typical fluid proportioner includes a pair of positive displacement pumps that individually draw in fluid from separate fluid hoppers and pump pressurized fluids to the mix manifold. The pumps are driven synchronously by a common motor, typically an air motor or hydraulic motor, having a reciprocating drive shaft. Such configurations are simple and easy to design. However, because of their two pumps to one motor configuration, these systems can be limited to certain control configurations and applications.

### SUMMARY

In one embodiment, a plural component dispensing system includes a first pump, a second pump, a first electric motor, a second electric motor, a first pressure sensor, a second pressure sensor, a first controller, a second controller, and a sprayer. The first pump discharges a first component. The second pump discharges a second component. The first electric motor drives the first pump as a function of a first drive signal. The second electric motor drives the second pump as a function signal. The first pressure sensor is located downstream of the first pump and senses a first component pressure. The second pressure sensor is downstream of the second pump and senses a second component pressure. The first controller is configured to produce the first drive signal, and the second controller is configured to produce the second drive signal. The first drive signal is delivered to the first electric motor as a function of the first component pressure and the second component pressure, and the second drive signal is delivered to the second electric motor as a function of the first component pressure and the second component pressure. The sprayer is connected to the first and second pumps, the sprayer is configured to create a mixture by mixing the first and second components, and the sprayer is configured to controllably discharge the mixture.

In another embodiment, a method for controlling a plural component spraying system includes sensing a first pressure of a first fluid component, and sensing a second pressure of a second fluid component. A first drive signal is provided to the first electric motor as a function of the first and second pressures. A second drive signal is provided to the second electric motor as a function of the first and second pressures. The first electric motor is operated as a function of the first drive signal. The second electric motor is operated in unison with the first electric motor, as a function of the second drive signal. The first pump is driven with the first electric motor to discharge a first component. The second pump is driven with the second electric motor in unison with the first pump to discharge a second component. The first and second components are received from the first and second pump, and mixed using a sprayer. The first and second components controllably dispensed using the sprayer.

### BRIEF DESCRIPTION OF THE DRAWINGS

FIG. 1 is an isometric view of a pumping system.

FIG. 2 is a schematic view of an embodiment of the pumping system of FIG. 1 that includes pressure switches.

FIG. 3 is a detailed schematic view of a portion of the schematic view of FIG. 2.

FIG. 4 is a schematic view of an embodiment of the pumping system of FIG. 1 that includes current sensors.

FIG. 5 is a schematic view of an embodiment of the pumping system of FIG. 1 that includes pressure sensors.

FIG. 6A is a cross-sectional view of a hose of the pumping system of FIG. 1 including a heater.

FIG. 6B is a cross-sectional view of the hose of FIG. 6A including a heater.

FIG. 7 is a graph illustrating a relationship between temperature and resistance for the heating elements of FIGS. 6A and 6B.

FIG. 8 is a diagram of an operation within the controllers of FIG. 1.

### DETAILED DESCRIPTION

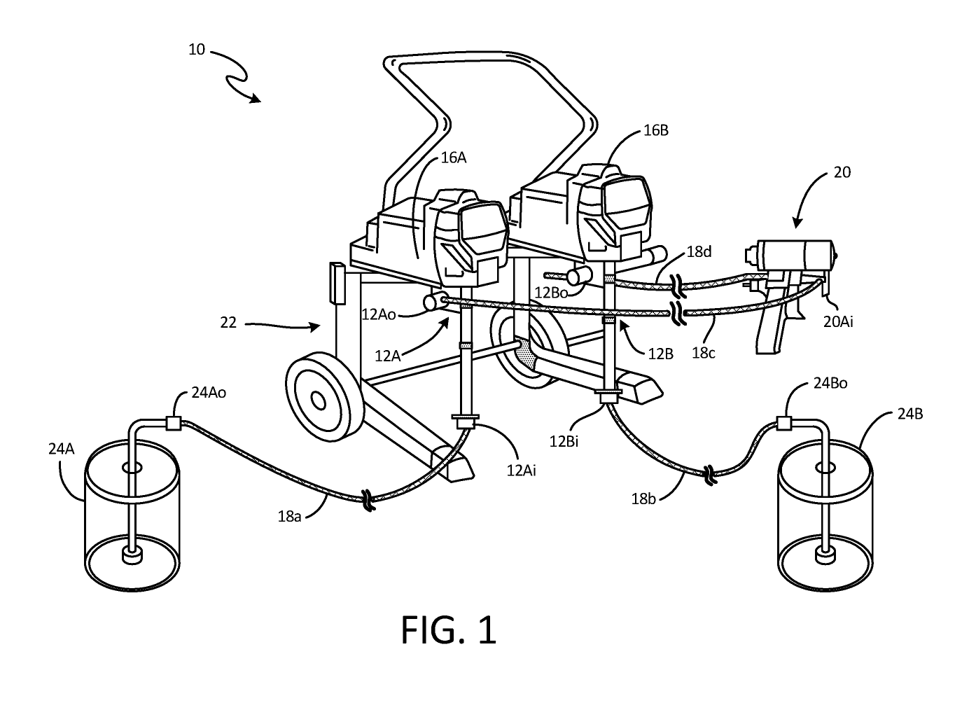

FIG. 1 is an isometric view of pumping system 10, which includes pumps 12A and 12B, controllers 14A and 14B, motors 16A and 16B, hoses 18a-18d, sprayer 20, cart 22, and component containers 24A and 24B. Pump 12A includes pump inlet 12Ai and pump outlet 12Ao. Pump 12B includes pump inlet 12Bi and pump outlet 12Bo. Sprayer 20 includes sprayer inlets 20Ai and 20Bi (only 20Ai is shown in FIG. 1). Component container 24A includes container outlet 24Ao and component container 24B includes container outlet 24Bo.

Component containers 24A and 26B can contain a volume of components A and B, respectively. Container outlets 24Ao and 24Bo are connected to pump inlets 12Ai and 12Bi, respectively, by hoses 18a and 18b, respectively. Pump outlets 12Ao and 12Bo are connected to sprayer inlets 20Ai and 20Bi, respectively, by hoses 18c and 18d, respectively.

Controllers 14A and 14B are electrically connected to motors 16A and 16B, respectively. Controllers 14A and 14B are physically connected to cart 22 as are pumps 12A and 12B and motors 16A and 16B. Cart 22 can support hoses 18a-18d and sprayer 20, but these components are movable relative to cart 22, whereas pumps 12A and 12B, controllers 14A and 14B, and motors 16A and 16B are secured to cart 22.

In operation of one embodiment, a user can select a desired component ratio through controllers 14A and 14B and enable pumping system 10. Once started, controllers 14A and 14B provide drive signals to drive motors 16A and 16B, respectively. Motors 16A and 16B drive pumps 12A and 12B, respectively, to reciprocate in unison (synchronously). Pumps 12A and 12B pump components A and B, respectively. Pump 12A draws component A from component container 24A through container outlet 24Ao, to pump inlet 12Ai through hose 18a. Pump 12A pressurizes and discharges component A from pump outlet 12Ao to sprayer inlet 20Ai through hose 18c. Pump 12B draws component B from component container 24B through container outlet 24Bo, to pump inlet 12Bi through hose 18b. Pump 12B pressurizes and discharges component B from pump outlet 12Bo to sprayer inlet 20Bi (not shown) through hose 18d. Sprayer 20 includes a mixing chamber (not shown) for mixing components A and B at an appropriate rate. A user can then controllably dispense a mixture of components A and B using sprayer 20.

In operation, pressure sensors (not shown) can sense the discharge pressure of pumps 12A and 12B. This pressure can be used to control the operation of motors 16A and 16B and therefore pumps 12A and 12B. This control method ensures that pumps 12A and 12B reciprocate in unison, thereby ensuring a consistent mixture of components A and B is delivered in a proper ratio to sprayer 20.

In another embodiment, a user can adjust a desired component ratio using controller 14A. Controller 14A can then adjust the speed of motor 16A and therefore the speed of pump 12A to meet the desired ratio of components A and B. The use of electronic motors as motors 16A and 16B can allow for simple and low cost control of pumps 16A and 16B.

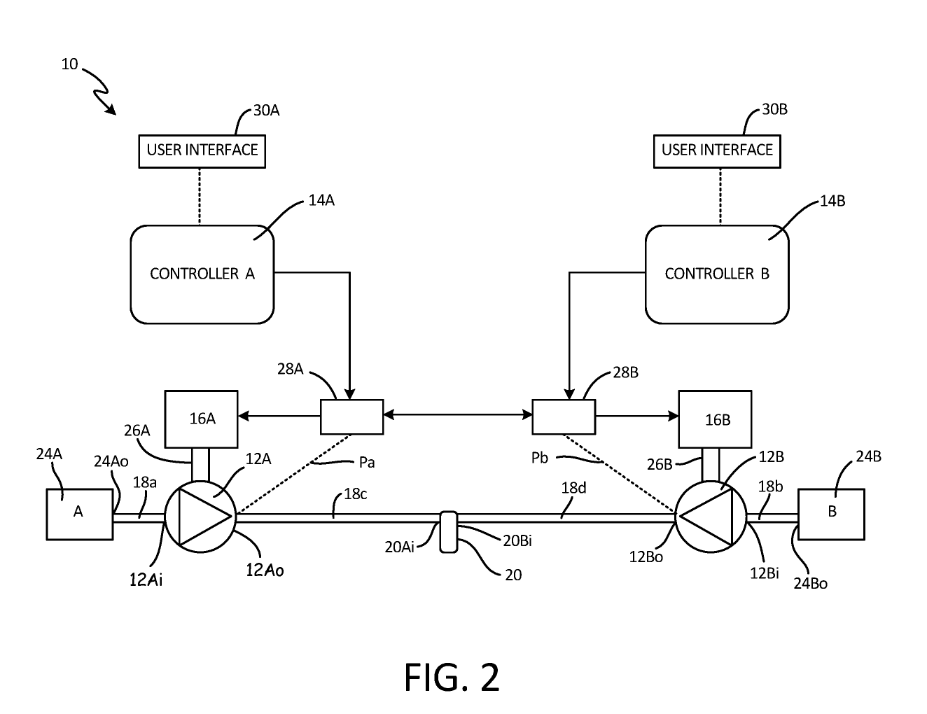

FIG. 2 is a schematic view of pumping system 10, which includes pumps 12A and 12B, controllers 14A and 14B, motors 16A and 16B, hoses 18a-18d, sprayer 20, component containers 24A and 24B, drive shafts 26A and 26B, pressure switches 28A and 28B, and user interfaces 30A and 30B. Pump 12A includes pump inlet 12Ai and pump outlet 12Ao. Pump 12B includes pump inlet 12Bi and pump outlet 12Bo. Sprayer 20 includes sprayer inlets 20Ai and 20Bi. Component container 24A includes container outlet 24Ao and component container 24B includes container outlet 24Bo. The components of FIG. 2 are connected consistently with FIG. 1.

Motors 16A and 16B couple to pumps 12A and 12B through drive shafts 26A and 26B, respectively. That is, motor 16A couples to pump 12A through drive shaft 26A and motor 16B couples to pump 12B through drive shaft 26B.

Pressure switch 28A is directly connected to the output of pump 12A to sense pressure Pa, and pressure switch 28B is directly connected to the output of pump to sense pressure Pb. In other words, pressure switch 28A is in fluid communication with pump outlet 12Ao and pressure switch 28B is in fluid communication with the pump outlet 12Bo.

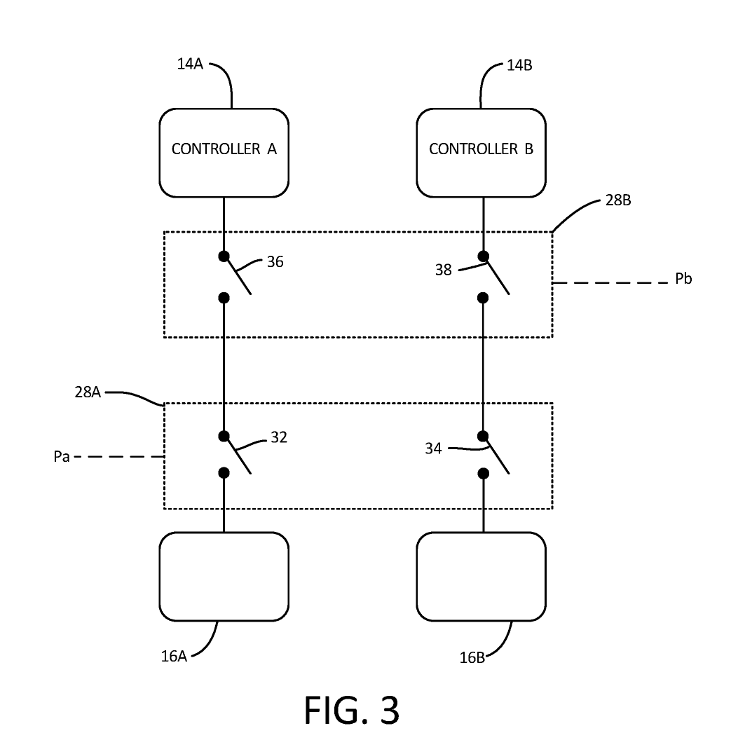

Controllers 14A and 14B are electrically connected to user interfaces 30A and 30B, respectively. Also, controllers 14A and 14B are each electrically connected to both pressure switches 28A and 28B. Pressure switch 28A is electrically connected to pressure switch 28B, which is electrically connected to motors 16A and 16B, as described in further detail in FIG. 3.

In operation of one embodiment, a user can connect component tanks 24A and 24B to hoses 18a and 18b, respectively. A user can then use interfaces 30A and 30B to enable pumping system 10 and set a minimum and maximum operating pressure on pressure switches 28A and 28b. When pumping system 10 is instructed to run by a user, controllers 14A and 14B send drive signals to pressure switches 28A and 28B that can be passed to motors 16A and 16B. Motors 16A and 16B drive pumps 12A and 12B, respectively, based on the drive signals. Pumps 12A and 12B are driven to pump components A and B, respectively, from component containers 24A and 26B, respectively, to sprayer 20. Motors 16A and 16B will drive pumps 12A and 12B, respectively, until a maximum pressure setpoint of pressure switches 28A and 28B is reached, at which point pressure switches 28A and 28B can stop the drive signals from reaching motors 16A and 16B. At any time when system 10 is enabled and sprayer 20 is sufficiently pressurized with components A and B by pumps 12A and 12B, a user can use sprayer 20 to controllably dispense a mixture of components A and B.

Pressure switches 28A and 28B monitor the discharge pressures of pumps 12A and 12B at pump outlets 12Ao and 12Bo, respectively, by measuring the pressure of hoses 18c and 18d, respectively. When the mixture is dispensed, the pressure of components A and B in the sprayer, and downstream of pumps 12A and 12B, respectively, will drop if pumps 12A and 12B are not running. When the pressure falls below a minimum pressure setpoint of pressure switches 28A and 28B, pressure switches 28A and 28B will close, allowing drive signals to be sent to motors 16A and 16B. This causes pumps 12A and 12B to run, increasing the pressure of components A and B until the maximum pressure setpoint is reached. When the maximum pressure setpoint is reached, pressure switches 28A and 28B will open, stopping the drive signals from reaching pumps 12A and 12B Similarly, if pumping system 10 is disabled, controllers 14A and 14B will not send drive signals to motors 16A and 16B, respectfully, and pumps 12A and 12B will not run. Pumps 12A and 12B cannot run again until the pressure in hoses 18c and 18d falls below the minimum pressure setpoint of pressure switches 28A and 28B.

Operation can consist of a cycle, where: controllers 14A and 14B send drive signals to pressure switches 28A and 28B, respectively; pressure switches 28A and 28B are closed, because the pressure in hoses is below the minimum pressure setpoint; the drive signal reaches motors 16A and 16B, driving motors 16A and 16B to drive pumps 12A and 12B, respectively; pumps 12A and 12B pump components A and B from tanks 24A and 24B, respectively, to sprayer 20 until the maximum pressure setpoint is reached at either or both of hoses 18c and 18d, opening pressure switches 28A or 28B, and stopping the drive signals from reaching motors 16A and 16B; the pressure of components A and B falls from use of sprayer 20 to dispense a mixture of components A and B; and, pressure switches close when the minimum pressure setpoint is reached—both pressure switches 28A and 28B close, allowing the drive signals to reach motors 16A and 16B, driving pumps 12A and 12B to build pressure of components A and B again. This cycle can repeat for as long as pumping system 10 is enabled.

Alternatively, if a dispensing rate of sprayer 20 causes the pressure of components A and B to stay below the maximum pressure setpoint of pressure switches 28A and 28B, pumps 12A and 12B can run continuously while sprayer 20 is in operation. Also, a user can stop spraying during the cycle, at which point pumps 12A and 12B will continue to run until one of pressure sensors 28A or 28B reaches maximum pressure. Also, a user can continue to spray when pumps 12A and 12B are not running. When this happens, sprayer 20 will continue to dispense the mixture at the appropriate ratio. The ratios can be maintained because the volume of components A and B stored between pumps 12A and 12B and sprayer 20, is very small. And when this small volume, which is the volume that can be sprayed without pumping, depletes, pressure will fall quickly, restarting pumps 12A and 12B. Additionally, check valves can be used in hoses 18a-18d to prevent the pressures from falling, preserving a pressure balance between components A and B.

If the user decides to stop spraying for a prolonged period, the user can first flush their equipment with oil or solvent, depending on what material is being applied as components A and B. If a user stops spraying for only a short period, the user can activate sprayer 20 again, which can restart at any place in the cycle of operation.

Components A and B can be fluids that create fluid compounds such as an epoxy or polyurethane. For example, components A and B can be a catalyst and a resin, respectively. In some applications, components A and B are individually inert; however; after mixing in sprayer 20, or somewhere in pumping system 10, downstream of pumps 12A and 12B, an immediate chemical reaction begins taking place between components A and B that results in cross-linking, curing, and solidification of the mixture.

Motors 16A and 16B are electric DC brushed motors, in one embodiment. In other embodiments, motors 16A and 16B can be other types of motors, such as AC motors or DC brushless motors in other embodiments.

Pumps 12A and 12B are linear piston pumps in one embodiment that draw in fluid on one stroke and discharge fluid in another stroke. In another embodiment, pumps 12A and 12B can be double-action pumps, such as a 2-ball or 4-ball double action pump. This means linear motion of the displacement shafts of pumps 12A and 12B will motivate fluid to travel from pump inlets 12Ai and 12Bi to pump outlets 12Ao and 12Bo, respectively. In other words, motion of displacement shafts of pumps 12A and 12B in either direction results in the pumping of components A and B.

In another embodiment, pressure switches 28A and 28B can be directly connected to hoses 18c and 18d, respectfully. In another embodiment pressure switches 28A and 28B can be directly connected to sprayer inlets 20Ai and 20Bi, respectfully.

FIG. 3 is a detailed schematic view of a portion of pumping system 10, including controllers 14A and 14B, motors 16A and 16B, hoses 18c and 18d, pressure switches 28A and 28B, and internal switches 32, 34, 36, and 38.

The components of FIG. 3 are connected consistently with FIGS. 1 and 2. FIG. 3 shows further detail of pressure switches 28A and 28B. Each of pressure switches 28A and 28B includes two internal electrical switches. Pressure switch 28A includes internal switches 32 and 34, and pressure switch 28B includes internal switches 36 and 38.

Controller A is electrically connected to internal switch 36 of pressure switch 28B, internal switch 32 of pressure switch 28A, and motor 16A. Internal switches 36 and 32 are wired in between controller 14A and motor 16A in electrical series. Controller B is electrically connected to internal switch 38 of pressure switch 28B, internal switch 34 of pressure switch 28A, and motor 16B. Internal switches 38 and 34 are wired in between controller 14B and motor 16B in electrical series.

As described above, pressure switch 28A senses the discharge pressure of pump 12A and pressure switch 28B senses the discharge pressure of pump 12B. Also, each of pressure switches 28A and 28B have two setpoints, a high pressure setpoint and a low pressure setpoint (or a minimum setpoint and a maximum setpoint). The high pressure setpoint is a target pressure value of pressure switches 28A and 28B. When a pressure as high or higher than the high pressure setpoint is sensed pressure switch 28A, internal switches 32 and 34 open and remain open until further action is taken by pressure switch 28A. Similarly, when a pressure as high or higher than the high pressure setpoint is sensed pressure switch 28B, internal switches 36 and 38 open and remain open until further action is taken by pressure switch 28B. The low pressure setpoint is a target pressure value of pressure switches 28A and 28B. When a pressure as low or lower than the low pressure setpoint is sensed by pressure switch 28A, internal switches 32 and 34 close and remain closed until further action is taken by pressure switch 28A. Similarly, when a pressure as low or lower than the low pressure setpoint is sensed by pressure switch 28B, internal switches 36 and 38 close and remain closed until further action is taken by pressure switch 28B. Pressure switches 28A and 28B can include additional switches, relays, sensors, and circuitry (not shown) to enable control of internal switches 32, 34, 36, and 38 based on both the high pressure setpoint and low pressure setpoint.

Pressure switches 28A and 28B are electrically connected between controller 14A and motor 16A, so that when either of internal switches 32 and 36 are open, current cannot flow to motor 16A. Similarly, pressure switches 28A and 28B are electrically connected between controller 14AB and motor 16B, so that when either of internal switches 34 and 38 are open, current cannot flow to motor 16B. This means both of internal switches 32 and 36 must be closed for current to flow from controller 14A to motor 16A, and both of internal switches 34 and 38 must be closed for current to flow from controller 14B to motor 16B.

In operation of one embodiment, internal switches 32 and 34 open when a maximum pressure setpoint is reached, for example 1000 psi, at pump outlet 12Ao. Therefore, if the maximum pressure is reached at the discharge of either of pumps 12A or 12B, current cannot flow from controller 14A to motor 16A and cannot flow from controller 14B to motor 16B, and pumps 12A and 12B cannot run. Conversely, the discharge pressure at both of pumps 12A and 12B must be below the maximum pressure setpoint for all of internal switches 32-38 to close and for controllers 14A and 14B to deliver current to motors 16A and 16B, allowing pumps 12A and 12B to run. Therefore, this configuration ensures that pumps 12A and 12B operate simultaneously.

Some two-component proportioners that discharge mixtures, such as polyurethane foam, can require a ratio of 1:1 having a low error of component ratio, to avoid ineffective mixtures and potentially hazardous conditions. A typical tolerable mixture error for polyurethane, for example, may be 5%. System 10 addresses this problem. The wiring configuration of controllers 14A and 14B, motors 16A and 16B, and pressure switches 28A and 28B ensures that motors 16A and 16B cannot operate individually. Therefore, pumps 12A and 12B must operate in unison, or synchronously, resulting in a mixture ratio accurate to 1-2%. Similar accuracies can be obtained with pumping system 10 for ratios other than 1:1, such as 2:1, 3:1, and the like, using methods described below.

Pressure switches 28A and 28B can be Bourdon, diaphragm, piston, or other type of pressure switch capable of using sensed pressure to operate an electronic switch. Internal switches 32, 34, 36, and 38 are shown as double pole single throw type electric switches in FIG. 3; however, internal switches 32, 34, 36, and 38 can be other types of switches in other embodiments.

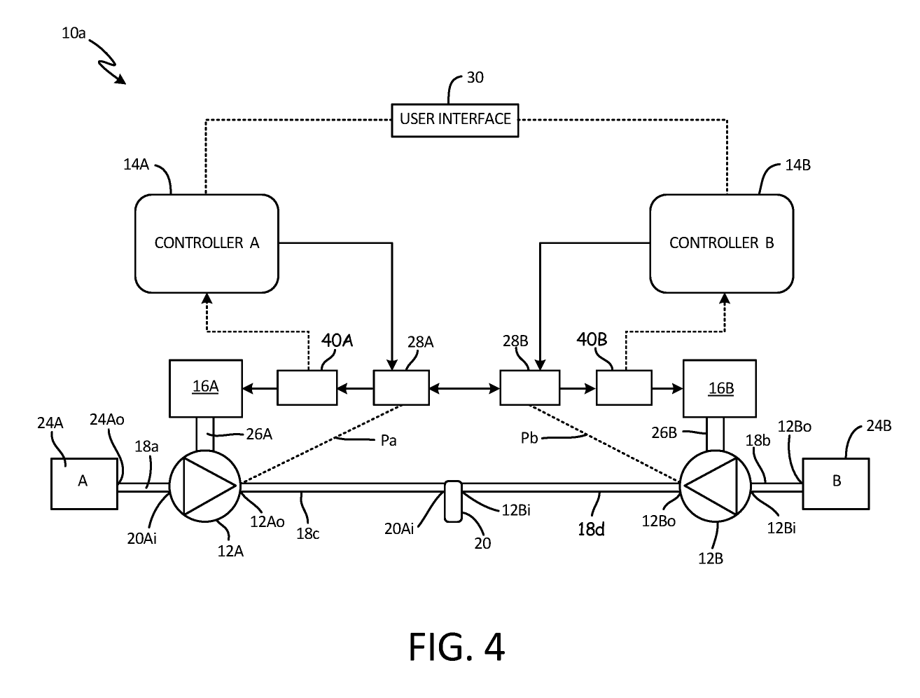

FIG. 4 is a schematic view of pumping system 10a, which includes pumps 12A and 12B, controllers 14A and 14B, motors 16A and 16B, hoses 18a-18d, sprayer 20, drive shafts 26A and 26B, component containers 24A and 26B, pressure switches 28A and 28B, user interface 30, and current sensors 40A and 40B. Pump 12A includes pump inlet 12Ai and pump outlet 12Ao. Pump 12B includes pump inlet 12Bi and pump outlet 12Bo. Sprayer 20 includes sprayer inlets 20Ai and 20Bi. Component container 24A includes container outlet 24Ao and component container 24B includes container outlet 24Bo.

The components of pumping system 10a shown in FIG. 4 are connected consistently with pumping system 10 of FIGS. 1-3, except that pumping system 10a only includes user interface 30, which is connected to both controller 14A and controller 14B. In operation of one embodiment, a user can use user interface 30 to communicate with both controllers 14A and 14B. For example, a user can use user interface 30 to turn on pumping system 10a, and can then set a flow rate for each of pumps 12A and 12B to set a desired ratio of component A to component B (A:B), such as 2:1, and the like. Use of a single user interface can reduce cost and simplify operation for a user. Pumping system 10a also differs in that it includes current sensors 40A and 40B. Current sensor 40A is electrically connected to pressure switch 28A and motor 16A, in electrical series. However, current sensor 40A can be located anywhere along the electrical connection between controller 14A and motor 16A. Similarly, current sensor 40B is electrically connected to pressure switch 28B and motor 16B, in electrical series. Current sensor 40B can also be located anywhere along the electrical connection between controller 14B and motor 16B. Current sensor 40A is also electrically connected to controller 14A and current sensor 40B is electrically connected to controller 14B.

In operation of one embodiment, current sensors 40A and 40B can measure current flowing to motors 16A and 16B, respectively, and produce current signals as a function of the current provided to each of motors 16A and 16B, respectively. Current signals produced by current sensors 40A and 40B can then be transmitted to controllers 14A and 14B, respectively, where controllers 14A and 14B can interpret and analyze the current signals.

For example, controllers 14A and 14B can analyze the waveform of the current signal. As motors 16A and 16B drive pumps 12A and 12B, the current draw of pumps 12A and 12B oscillates over time, creating a sinusoidal waveform. At the top of each pump stroke pump pressure is the highest, and therefore the greatest work is required. As the pump strokes down, the pressure falls along with the amount of work required. The reverse occurs as the piston moves upward, drawing fluid in. As the pump repeatedly strokes up and down, its current creates a sinusoidal wave, where current is highest at the top of its stroke and lowest at the bottom of its stroke. With this knowledge, controller 14A can use the waveform provided by current sensor 40A to count strokes of pump 16A. Additionally, controller 14A can estimate the position of the piston of pump 12A at any point in its stroke. The same calculations can be performed by controller 14B of the position of the piston within pump 16B.

In another example, controller 14A can use the peaks and troughs to count the strokes of pump 12A. Controllers 14A and 14B can use information about piston stroke to estimate the flow rate of each of pumps 12A and 12B, respectively. By measuring time and by knowing the pump flow rate for each of pumps 12A and 12B, controllers 14A and 14B can determine a volumetric flow rate for each of pumps 12A and 12B, as a function of their piston position determined from the current waveform.

Also, controller 14A and 14B can analyze the waveform of the current signals from current sensors 40A and 40B to determine pumping pressure. Each waveform has a correlation of current amplitude to pump pressure. Therefore, by measuring current amplitude, controllers 14A and 14B can determine pumping pressure.

These calculations allow controllers 14A and 14B to receive feedback on operation of pumping system 10a, allowing for better control over the components of pumping system 10a and allowing for adjustments of the operation of pumping system 10a to be made and monitored by controllers 14A and 14B.

In operation of another embodiment, pumping system 10a can pump and spray components A and B at different flow rates, to produce a component ratio other than 1:1. In this embodiment, a user can use user interface 30 to adjust to adjust the desired speed of one of the motors, for example motor 16A. After the pump speed or pumping ratio is set by a user, controller 14A can adjust its drive signal sent to motor 16A. That is, controller 14A can send a drive signal to operate motor 16A at a higher rate of speed. This, in turn, operates pump 12A to pump fluid from component container 26A to sprayer 20 at a higher flow rate than pump 12B provides fluid to sprayer 20. This creates ratio of component A to component B greater than 1:1.

The drive signal can be adjusted in many different ways. For example, the drive signal voltage can be adjusted manually by a user through a variable resistor. In this embodiment, controller 14A monitors the current signal from current sensor 40A and determines the speed of motor 16A and therefore pump 12A. Controller 14A can provide a user with feedback, such as the speed of pump 12A. This allows the user to determine whether the user's manual adjustments made to the speed of pump 12A match the user's desired pump speed.

In another embodiment, a user can enter the desired pumping speed into user interface 30, which can then communicate the desired pumping speed to controller 14A. Controller 14A can then adjust the drive signal using an AC rectifier and triac controlled pulse width modulator, or another means of adjusting effective voltage supplied to motor 16A. Controller 14A can then compare the desired pumping speed to the calculated pump speed derived from the current signal. If the calculated pumping speed does not meet the desired pumping speed, controller 14A can adjust the drive signal in an attempt to obtain a calculated pumping speed that matches the desired pumping speed.

In one embodiment, pressure switches 28A and 28B can be used to ensure that motors 16A and 16B (and therefore pumps 12A and 12B) operate in unison, as discussed above. This, together with speed control of motors 16A and 16B ensures that speed adjustments made by a user or by controller 14A are held constant during operation of pumping system 10a. This allows pumps 12A and 12B to operate in unison, or synchronously, resulting in a mixture ratio accurate to 1-2% with ratios other than 1:1, such as 2:1, 3:1, and the like.

In one embodiment, pumping system 10a can use only a single current sensor. For example, pumping system 10a can include only current sensor 40A to analyze current traveling to motor 16A. This embodiment can be cost effective, especially when only the flow rate of component A has to be adjusted.

In one embodiment, desired speed of motors 16A and 16B can be adjusted through a variable resistor, such as a potentiometer. In another embodiment, the user can digitally adjust the speed of motor 16A through a keypad or touch screen of user interface 30A. Alternatively, user interface 30A can receive a desired pumping ratio to be sent to controller 14A.

In one embodiment, a cycle switch can be used on each of pumps 12A and 12B to count strokes, which can be used to determine pumping flow rates for each of pumps 12A and 12B.

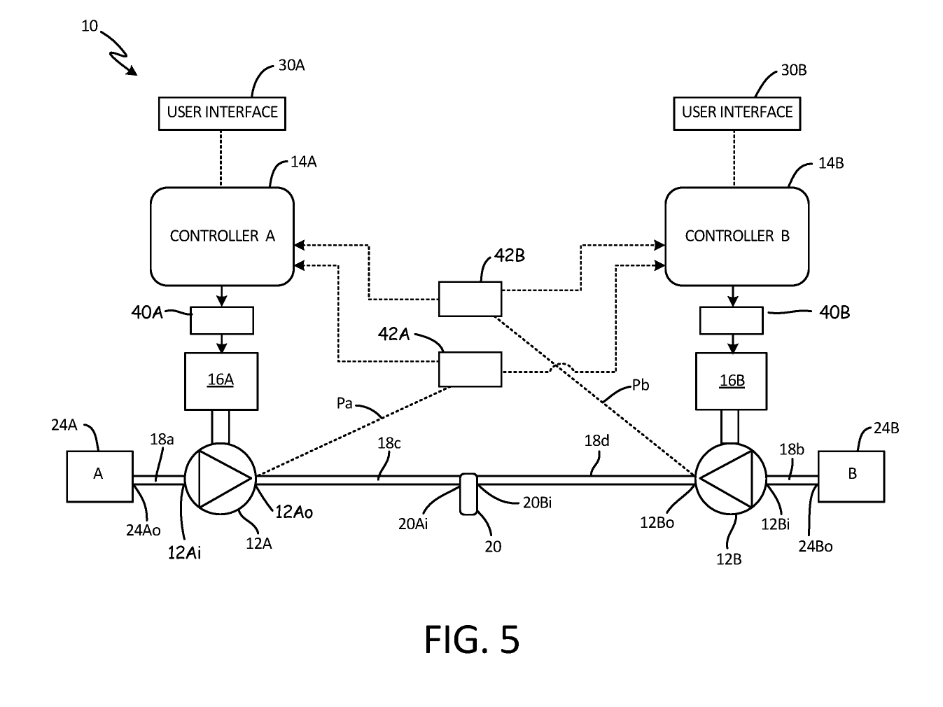

FIG. 5 is a schematic view of pumping system 10b, which includes pumps 12A and 12B, controllers 14A and 14B, motors 16A and 16B, hoses 18a-18d, sprayer 20, drive shafts 26A and 26B, component containers 24A and 26B, user interfaces 30A and 30B, current sensors 40A and 40B, and pressure sensors 42A and 42B.

Pumping system 10b is connected similarly to pumping systems 10 and 10a; however, in pumping system 10b, pressure sensors 42A and 42B are in fluid communication with hoses 18c and 18d. Pressure sensor 42A is electrically connected to controllers 14A and 14B, and pressure sensor 42B is electrically connected to controllers 14A and 14B.

Pressure sensors 42A and 42B can be differential, absolute, or gauge pressure sensors for determining the pressure of components A and B downstream of pumps 12A and 12B, respectively. Pressure sensors 42A and 42B can be capacitive, electromagnetic, piezoelectric, or another type of pressure sensor capable of producing a pressure signal as a function of pressure of a measured fluid. In one embodiment, pressure sensors 42A and 42B produce pressure signals as a function of the pressure of components A and B, respectively.

Also, in pumping system 10b, controllers 14A and 14B are directly connected to motors 16A and 16B, respectively, with only current sensors 40A and 40B, in between, respectively. Additionally, user interface 30A is connected to controller 14A and user interface 30B is electrically connected to controller 14B.

In operation of one embodiment, pressure sensors 42A and 42B produce pressure signals as a function of the pressure of components A and B, respectively. Pressure sensors 42A and 42B send a signal to each of controllers 14A and 14B. In another embodiment the pressure signals can be sent to only one controller. Controllers 14A and 14B can receive and analyze the pressure signals, and can use the pressure signals to control pumping system 10b.

In operation of one embodiment, controllers 14A and 14B can use the pressure signals to ensure that pumps 12A and 12B operate in unison. For example, if controller 14A determines that the pressure of component B, downstream of pump 12B falls, is lower than the pressure of component A, controller 14A can lower the speed of motor 16A (and therefore pump 12A) or can stop motor 16A. If pumps 12A and 12B consistently fail to stop at, or around, the same time, controllers 14A and 14B can send an alarm to user interfaces 30A and 30B.

Also, controllers 14A and 14B can use pressure signals from pressure sensors 42A and 42B to determine discharge pressure of pumps 12A and 12B. Because both pressure signals are sent to each of controllers 14A and 14B, the pressure signals can be compared by both controllers 14A and 14B. If either of controllers 14A or 14B determine that there is a pressure differential outside a specified tolerance, controllers 14A or 14B can produce an alarm for user interfaces 30A and 30B, or for a remotely mounted panel or controller. Similarly, controllers 14A and 14B can produce an alarm if either or both of the discharge pressures are above or below a specified maximum or minimum.

Pressure differentials can be caused by a failed component, clogged sprayer 20, or empty component tank. Controller 14A can output a message or alarm to user interface 30 that component container 26A is empty if the discharge pressure of pump 12A falls rapidly. Additionally, controller 14A can output a message or alarm to user interface 30 that sprayer 20 is clogged if the discharge pressure increases slowly over time.

Further, as discussed above, controllers 14A and 14B can determine pumping pressure by measuring current amplitude from the current signal produced by current sensors 40A and 40B. Therefore, having the ability to measure pump discharge pressure through two methods, controllers 14A and 14B can determine if a sensor has failed or has another problem. For example, if pressure sensors 42A and 42B determine that the discharge pressure of each of pumps 12A and 12B are equal, but current sensor 40A produces a signal that indicates that the speed of pump 12A is half of the speed of pump 12B, controller 14A can determine that there is likely a problem with current sensor 40A and can produce an alarm.

Pumping system 10, 10a, or 10b also offers versatility. Pump 12A, controller 14A, and motor 16A can be removed from pumping system 10, 10a, or 10b, and operated individually. That is, once pump 12A, controller 14A, and motor 16A are removed from pumping system 10, 10a, or 10b, pump 12A, controller 14A, and motor 16A can be operated while pump 12B, controller 14B, and motor 16B are not operated. This allows a user to spray single component fluids, such as paints, using components of pumping system 10, 10a, or 10b.

Though pumping systems 10, 10a, and 10b have been described as applying to two-component proportioner pumping systems, or pumping systems including two components, the methods of this disclosure can apply to pumping systems for pumping more than two components. That is, the methods of this disclosure can apply to a three component pumping system including, for example, three pumps, three electric motors, three controllers, and a single sprayer that dispense a mixture of three components.

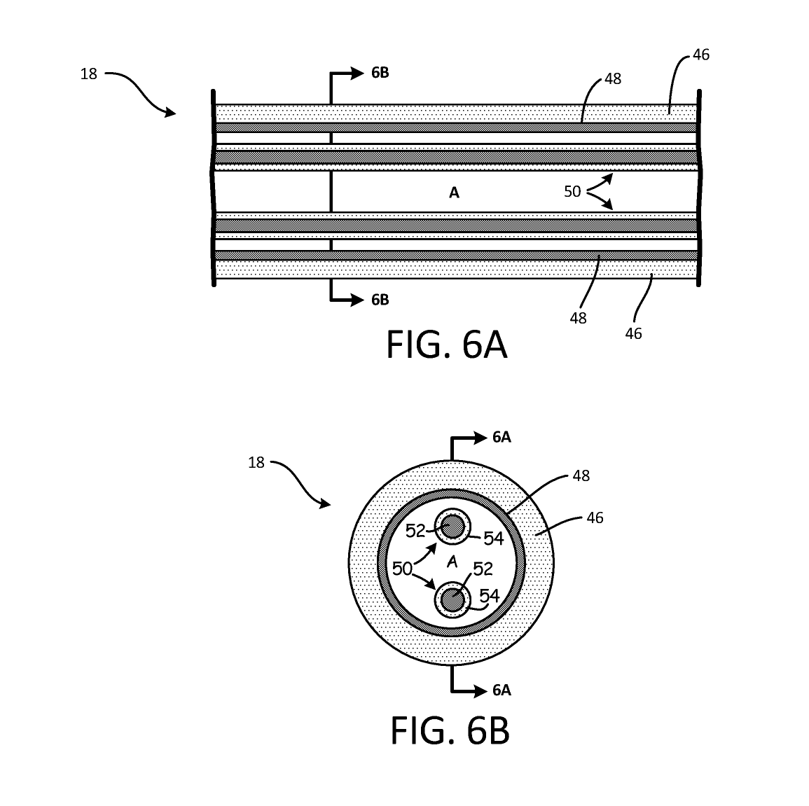

FIG. 6A is a cross-sectional view of hose 18 of pumping system 10 from the perspective 6A-6A of FIG. 6B. FIG. 6B is a cross-sectional view of hose 18 from the perspective 6B-6B of FIG. 6A. FIGS. 6A and 6B are discussed concurrently. The description below focuses on controller 14A and component A, however, the description and methods apply to controller 14B and component B. Hose 18 shown in FIGS. 6A and 6B can be any or all of hoses 18a-18d of FIGS. 1-5.

Hose 18 includes outer insulator 46, shield 48, and resistance heaters 50. Also shown in FIGS. 6A and 6B is component A. Each of resistance heaters 50 include heating element 52 and inner insulators 54.

Outer insulator 46 is cylindrical tubing with a high thermal resistance (R-value), such as closed-cell polyethylene and the like, enclosing shield 48. Shield 48 is an electrical shield that is also cylindrical, or tubular, and is connected to a radially inner surface of insulator 46. Resistance heaters 50 include heating element 52, which are a cylindrical, wire-like, electrical resistance heating elements. Each of heating elements 52 is encased in inner insulator 54, which is an electrical insulator. Heating elements 52 are electrically connected to controller 14A, from which heating element 52 receives power. Shield 48 is grounded.

In operation of one embodiment, controller 14A can send power to hose 18, specifically heating elements 52. Heating elements 52 dissipate the electrical power in the form of heat through inner insulator and into component A. The heat given off by heating elements 52 into component A raises the temperature of component A within hose 18. Insulator 62 prevents heat from escaping from component A, keeping component A relatively warm or hot, and increasing thermal efficiency.

Heating a hose has several benefits including preventing clogged and sprayers, and lowering pressure drop through pumping system 10, 10a, or 10b, which increases pumping system efficiency. Placing heating elements 52 into component A increases heat transfer between heating elements 52 and component A. This allows heating elements 52 to heat up component A quickly and efficiently. Placing heating elements 52 inside shield 48 and in component A also protects heating elements 52 from breaking, as elements 52 are not as susceptible to external forces, as may be the case with some prior art.

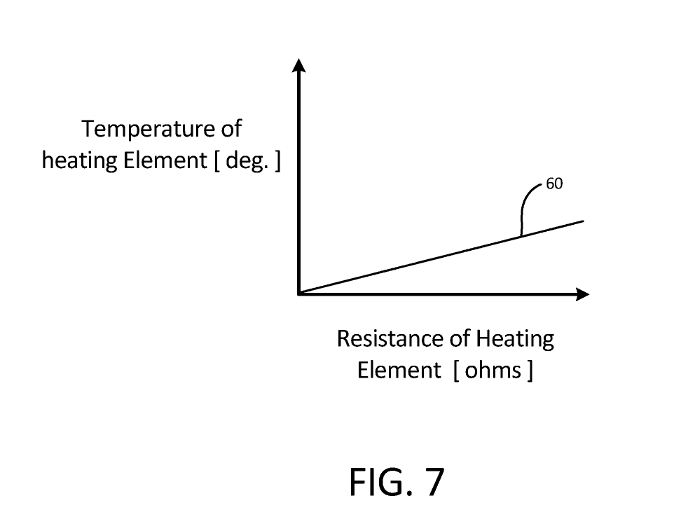

FIG. 7 is a graph illustrating a relationship between temperature and resistance for heating elements 52. FIG. 7 shows Resistance of Heating Element on the x-axis and Temperature of Heating Element on the y-axis, referring to the resistance and temperature of heating elements 52, respectively. Line 60 represents the known relationship between temperature and resistance for each of heating elements 52.

In one embodiment, controller 14A can measure the current provided to heating elements 52 using a current sensor. Also, heating elements 52 can be made of an alloy having a known resistance to temperature relationship, where changes in resistance due to changes in temperature are detectable.

In one example, controller 14A can then determine the temperature of one of heating elements 52 by analyzing the current and voltage drawn by heating element 52. That is, controller 14A can determine the resistance of heating element 52 based on the current drawn by heating element 52 (provided to controller 14A by a current sensor) and the voltage supplied by controller 14A. Controller 14A can then determine a temperature of heating element 52 based on the calculated resistance of heating element 52 and the known relationship between resistance and temperature of heating element 52. Controller 14A can then control the power supplied to heating element 52 based on the calculated temperature of heating element 52. For example, a maximum heating element temperature can be set, and controller 14A can reduce or eliminate power delivered to heating element 52 when that temperature is met. A minimum temperature setpoint can also be set, wherein controller 14A sends power to heating elements 52 when the temperature of heating element falls below the minimum temperature setpoint.

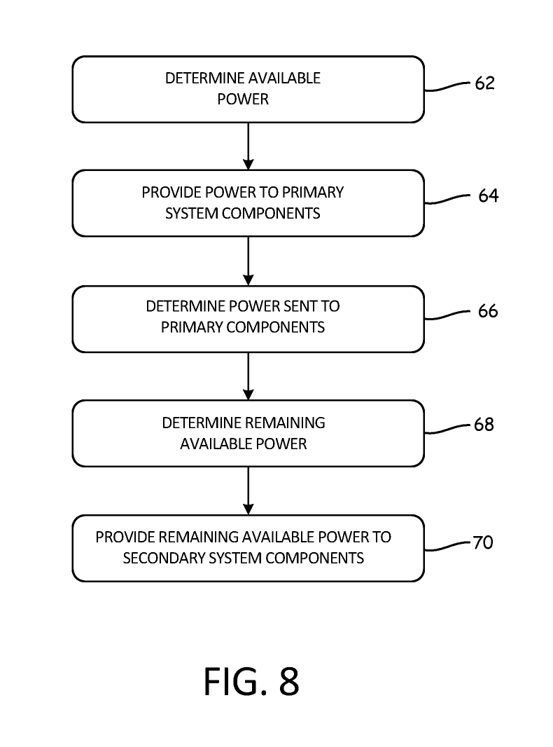

FIG. 8 is a diagram of an operation within controllers 14A and 14B, including the steps determine available power 62, provide power to primary system components 64, determine power sent to primary components 66, Determine remaining available power 68, and provide remaining available power to secondary system components 70.

In one embodiment, pumping system 10, 10a, or 10b can perform a power calculation, where first, controllers 14A and 14B perform step 62 (determine available power), where controllers 14A and 14B determine the amount of power available to pumping system 10, 10a, or 10b. Next, controllers 14A and 14B perform step 64 (provide power to primary system components), where controllers 14A and 14B distribute power to components that are prioritized as primary power consumers, such as motors 16A and 16B. Then, controllers 14A and 14B perform step 66 (determine power sent to primary components), where controllers 14A and 14B use a sensor or sensors to determine how much power is sent to the primary components. Next, controllers 14A and 14B perform step 68 (determine remaining available power), where controllers 14A and 14B subtract the available power determined in step 62 from the remaining available power determined in step 68. The result of this calculation is the remaining available power for distribution by controllers 14A and 14B. Finally, controllers 14A and 14B can perform step 70 (provide or distribute the remaining available power to secondary system components), where controllers 14A and 14B distribute the remaining available power calculated in step 68, such as heating elements 52 to heat hoses 18.

In one example of this embodiment, pumping system 10, 10a, or 10b can receive its power from an outlet or receptacle, such as a ground-fault interrupted 120 volt, 20 amp service. In this embodiment, pumping system 10, 10a, or 10b will attempt to not draw more than 20 amps. To provide as much heat as possible to component A, controller A can calculate the power being drawn by motor 16A and controller 14A. Controller 14A can then subtract the power drawn by these components from the 20 amps available. Controller can then allocate the remainder of the 20 amps available to heating elements 52, up to the maximum temperature of heating elements 52. Also, controllers 14A and 14B can perform these calculations, assuming an equal split in power. In another embodiment, the power for all of hoses 18a-18d (of FIGS. 2, 4, and 5) can be provided by only one of controllers 14A and 14B.

Although the present invention has been described with reference to preferred embodiments, workers skilled in the art will recognize that changes may be made in form and detail without departing from the spirit and scope of the invention.

1. A plural component dispensing system comprising:
a first pump that discharges a first component;
a second pump that discharges a second component;
a first electric motor that drives the first pump as a function of a first drive signal;
a second electric motor that drives the second pump as a function of a second drive signal;
a first pressure sensor located downstream of the first pump that senses a first component pressure;
a second pressure sensor downstream of the second pump that senses a second component pressure;
a first controller configured to produce the first drive signal that is delivered to the first electric motor as a function of the first component pressure and the second component pressure;
a second controller configured to produce the second drive signal that is delivered to the second electric motor as a function of the first component pressure and the second component pressure; and
a sprayer connected to the first and second pumps, wherein the sprayer is configured to create a mixture by mixing the first and second components, and wherein the sprayer is configured to controllably discharge the mixture.

2. The plural component dispensing system of claim 1, wherein the first pressure sensor and second pressure sensor are pressure switches.

3. The plural component dispensing system of claim 2, wherein the first pressure sensor and second pressure sensor include switch contacts that are electrically connected in series.

4. The plural component dispensing system of claim 1, wherein the first pressure sensor produces a first pressure signal as a function of the first pressure and delivers the first pressure signal to the first controller and the second controller, and wherein the second pressure sensor produces a second pressure signal as a function of the second component pressure and delivers the second pressure signal to the first controller and the second controller.

5. The plural component dispensing system of claim 4, wherein the first controller produces the first drive signal as a function of the first pressure signal and the second pressure signal, and the second controller produces the second drive signal as a function of the first pressure signal and the second pressure signal so that the first and second pumps are driven in unison by the first and second electric motors to deliver a desired ratio of the first and second components to the sprayer.

6. The plural component dispensing system of claim 1, and further comprising a first current sensor that produces a first motor current signal as a function of a current draw of the first electric motor.

7. The plural component dispensing system of claim 6, wherein the first controller is configured to determine a first pump speed as a function of the motor current signal.

8. The plural component dispensing system of claim 7, and further comprising a user interface configured to receive a user input selecting a desired ratio of the first component to the second component.

9. The plural component dispensing system of claim 8, wherein the controller is configured to produce the first drive signal as a function of the desired ratio of the first component to the second component.

10. The plural component dispensing system of claim 9, wherein the first controller is configured to produce the first drive signal as a function of the desired ratio of the first component to the second component, the pump speed, the first component pressure, and the second component pressure.

11. The plural component dispensing system of claim 10, wherein the first and second controllers produce the mixture at an equal ratio of the first component to the second component.

12. The plural component dispensing system of claim 7, wherein the first controller is configured to determine a first component pressure as a function of the motor current signal.

13. The plural component dispensing system of claim 12, and further comprising a second current sensor that produces and delivers to the first controller a second motor current signal as a function of a current draw of the second electric motor, wherein the first controller is configured to determine a second component pressure as a function of a second motor current signal, and wherein the first controller is configured determine a pressure balance as a function of the first component pressure and the second component pressure.

14. The plural component dispensing system of claim 13, wherein the first controller is configured to produce an alarm when the pressure balance is outside of a pressure balance tolerance.

15. The plural component dispenser of claim 1 and further comprising:
a first hose connecting the sprayer to a container of the first component;
a second hose connecting the sprayer to a container of the second component; and
a first heater insider the first hose and a second heater inside the second hose.

16. The plural component dispenser of claim 15, wherein each of the first and second heaters comprise:
an outer insulator;
a shield that is grounded and connected to a radially inner surface of the outer insulator, and configured to contain one of the first or second components; and
a resistance heater inside the shield and contacting the first or second component and configured to heat the first or second component.

17. The plural component dispenser of claim 16, wherein:
one of the first and second controllers is configured to determine a heater current draw as a function of a current drawn from the controller to the resistance heater; and
one of the first and second controllers is configured to allocate current to the resistance heater as a function of the first current signal and the second current signal.

18. A method for controlling a plural component spraying system, the method comprising:
sensing a first pressure of a first fluid component;
sensing a second pressure of a second fluid component;
providing a first drive signal to the first electric motor as a function of the first and second pressures;
providing a second drive signal to the second electric motor as a function of the first and second pressures;
operating the first electric motor as a function of the first drive signal;
operating the second electric motor in unison with the first electric motor, as a function of the second drive signal;
driving a first pump with the first electric motor to discharge a first component;
driving a second pump with the second electric motor in unison with the first pump to discharge a second component;
mixing the first and second components received from the first and second pump, using a sprayer; and
dispensing the first and second components controllably using the sprayer.

19. The method of claim 18 and further comprising:
receiving a user input selecting a desired pumping ratio.

20. The method of claim 19 and further comprising;
receiving a motor current signal that is a function of a current draw of the first pump; and
determining a first pump speed as a function of the current signal.

21. The method of claim 20 and further comprising:
producing the first drive signal as a function of the desired pumping ratio, the first pump speed, the first pressure signal, and the second pressure signal.
